(19) United States
(12) Patent Application Publication
(10) Pub. No.: US 2004/0157599 A1
(43) Pub. Date: Aug. 12, 2004

(54) Reducing the size of preferred roaming list tables

(76) Inventors: Alejandro Raul Holcman, San Diego, CA (US); Nakul Duggal, San Diego, CA (US)

Correspondence Address: Qualcomm Incorporated, Patents Department, 5775 Morehouse Drive, San Diego, CA, 92121-1714, US

(21) Appl. No.: 10/365,248

(22) Filed: Feb. 11, 2003

(51) Int. Cl. H04Q 7/20

(52) U.S. Cl. 455/432.1; 455/435.2

(57) ABSTRACT

A method and apparatus for enabling roaming for a mobile device in a mobile communications network. A preferred roaming list (PRL) including a first plurality of system identification (SID) numbers that identifies a subset of available roaming systems is obtained. A parameter block including at least a second plurality of SID numbers and a corresponding plurality of SID ranges is also obtained. Each SID number in the parameter block is matched to a SID number in the PRL. The subset of available roaming systems is then expanded using the matched SID number and a corresponding SID range in the parameter block.

### BACKGROUND

1. Field

The present invention relates generally to telecommunication systems, and more specifically to controlling roaming operation of mobile units in such systems.

2. Background

In mobile telephone systems, when a mobile telephone user moves outside the user's home area for service coverage (referred to as “roaming”), the mobile telephone is often switched from the home system to an alternate system service provider so that service can continue. In order to switch the user to an alternate system service provider, the mobile telephone will typically access system records in the System Table of a Preferred Roaming List (PRL) stored in the memory of the mobile telephone or in a Removable User Identity Module (R-UIM). Based on the system records stored in the System Table, the mobile telephone selects an alternate system service provider that can be used to continue service for the user and, based on this selection and the associated information stored in the PRL system records, the mobile telephone can automatically access the selected service provider for the user.

A standard data format to be used for system records in the System Table of a PRL is described in the Telephone Industry Association/Electronics Industry Association standard (TIA/EIA-683-B-2001) “Over-the-Air Service Provisioning of Mobile Stations in Spread Spectrum Systems”, hereinafter referred to as “the 683-B Standard”. Hence, the System Table is used to assist the mobile telephone to locate a preferred mobile communication network from an alternate system service provider upon power-on of the telephone when the mobile telephone is located outside the subscribed home service area.

The 683-B Standard provides that each system record in the PRL include a service provider System Identification (SID) number. This 15-bit data field may include specific identification data that the mobile telephone can use to acquire a service provider system. The system record may also include a Network Identification (NID) number associated with the SID number and stored in the 16-bit NID field if the 2-bit NID_INCL field of the system record is set to include the NID number. The system record further includes a 1-bit “Geographic Region” data field (called GEO) to indicate when systems in the PRL are from a new geographic region. Other data fields in the system record include a 1-bit “Preferred/Negative System” (PREF_NEG) field, a 1-bit Relative Priority Indicator (PRI) field, a 9-bit Acquisition Record Index (ACQ_INDEX) field, and an 8-bit Roaming Indication Value (ROAM_IND) field.

Table 1 shows the system record format of the System Table according to Section 3.5.5.3 in the 638-B Standard.

TABLE 1
System Record Format

| System Record Field | Length (bits) |
|---|---|
| SID | 15 |
| NID_INCL | 2 |
| NID | 0 OR 16 |
| PREF_NEG | 1 |
| GEO | 1 |
| PRI | 0 OR 1 |
| ACQ_INDEX | 9 |
| ROAM_IND | 0 OR 8 |

As stated above, under the 683-B Standard, each service provider SID of a system record in the System Table requires an explicit entry. Each system record entry may require up to 53 bits in the System Table. For service providers with many cellular network deployments, there may be a large number of roaming partner systems. Each one of these partner systems can have multiple SID entries. Therefore, the requirement of having one system record entry for each SID can significantly increase the size of the System Table. Furthermore, as service providers enter into roaming agreements with other system providers, more system record entries need to be included in the System Table, which makes the PRL System Table even more complex. The size of the System Table may eventually reach the limit of the available memory space in the mobile telephone or in the R-UIM card, which typically has low storage capability.

The increase in the size of the PRL may also adversely affect System Table updates. For example, using Over-the-Air Service provisioning (OTASP), a mobile telephone subscriber can be provided with the flexibility of modifying some of the operating parameters within a mobile telephone from an over-the-air function/customer service center (OTAF/CSC) that permits downloading of additional parameters and data. However, if the size of the System Table is relatively large, it can take an excessive amount of time to download the PRL over the air from the OTAF/CSC to the mobile telephone memory or the R-UIM card.

From the discussion above, it should be apparent that there is a need for providing more efficient and compact method for storage of system record data in the System Table. The present invention solves this need.

### SUMMARY

Embodiments disclosed herein overcome the above-stated shortcomings by providing a more efficient and compact way to represent a large number of roaming systems in the System Table of a Preferred Roaming List (PRL). A compressed format System Table is stored in accordance with a roaming system range parameter block. The compressed System Table includes a first plurality of system identification (SID) numbers that identifies a subset of available roaming systems. The system range parameter block includes at least a second plurality of SID numbers and a corresponding plurality of SID number ranges. Each SID number in the system range parameter block corresponds to a matching SID number in the PRL. The subset of available roaming system SID numbers can be expanded using the matched SID number and a corresponding SID range in the system range parameter block.

In one aspect, roaming is enabled for a mobile device in a mobile communications network by accessing a subset list of available roaming systems identified with a list of roaming system identification numbers, and by accessing a roaming system range parameter block. The range parameter block includes a plurality of roaming system SID number ranges to identify roaming systems in addition to the subset list. The expanded list of available roaming systems is generated using the subset list of available roaming systems and the roaming system SID number range. Thus, it is not necessary to store the complete list of SID numbers. This reduces the memory requirement of the mobile device.

In another aspect, a mobile device in a mobile communications network includes a memory and a processor. The memory is configured to store a subset list of available roaming systems identified with a list of roaming system SID numbers, and to store a roaming system range parameter block. The range parameter block includes a plurality of roaming system SID number ranges to identify additional roaming systems. The processor is adapted to generate an expanded list of available roaming system SID numbers using the subset list of available roaming systems and the roaming system range parameter block stored in the memory.

Other features and advantages of the present invention should be apparent from the following descriptions of the exemplary embodiments, which illustrates, by way of example, the principles of the invention.

### BRIEF DESCRIPTION OF THE DRAWINGS

FIG. 1 illustrates a method for reducing memory requirements for a PRL in accordance with an exemplary embodiment of the invention;

FIG. 2 illustrates an exemplary process for matching and expanding a compressed System Table using an SID range Parameter Block;

FIGS. 3A and 3B illustrate an exemplary process for generating a compressed System Table and an SID range Parameter Block using a conventional System Table with all the SID entries;

FIG. 4 is a block diagram of an exemplary mobile telephone in communication with an over-the-air function/customer service center (OTAF/CSC); and

FIG. 5 is a block diagram illustrating a system that incorporates and integrates modules such as a processor, a memory, and a program product, to enable roaming in a mobile communications network.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

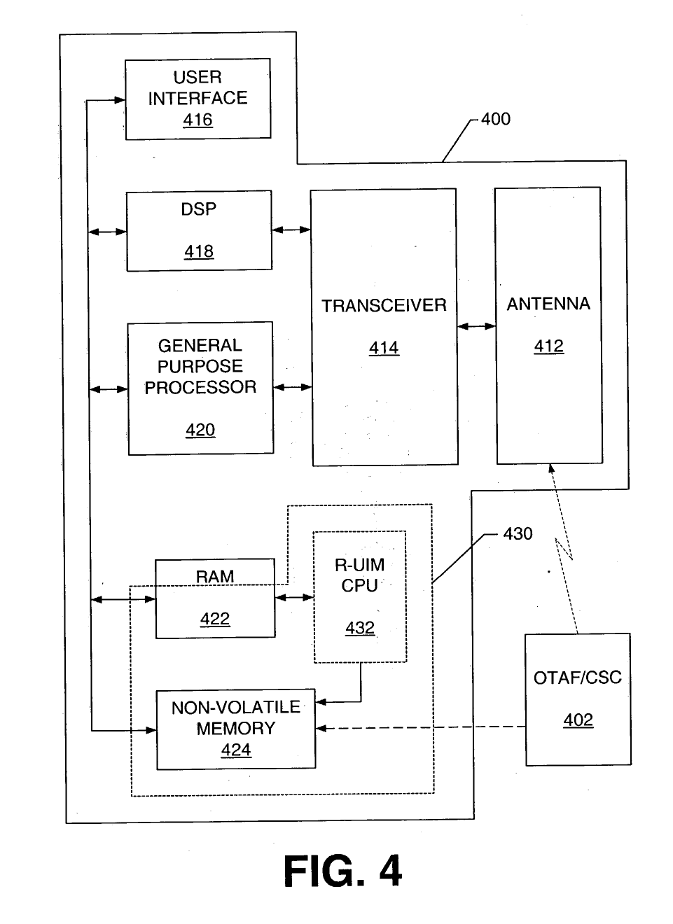

In recognition of the above-stated shortcomings associated with a conventional format of the system records in the System Tables, this disclosure describes exemplary embodiments for providing a more efficient and compact way to represent a large number of roaming systems in the System Table of the Preferred Roaming List (PRL) that is maintained in accordance with the 683-B standard. In particular, entries in the System Table that would ordinarily comprise a series of consecutive SID numbers for the same service provider are instead formatted using ranges of system identification (SID) numbers, rather than a single SID number per system record entry. Consequently, for purposes of illustration and not for purposes of limitation, the exemplary embodiments of the invention are described in a manner consistent with such use, though the invention is not so limited. FIG. 4 is a block diagram that illustrates a mobile telephone that operates in accordance with the invention. In other embodiments, other wireless or mobile devices, such as a personal digital assistant (PDA), can be used in place of the mobile telephone.

Blocks of SID numbers are assigned (typically by a government entity, e.g., Federal Communications Commission (FCC) in the USA) in consecutively-ordered (odd- or even-numbered) ranges to service providers and carriers. Therefore, system record entries in a System Table will include a series of consecutively-numbered SID entries with each entry having substantially similar information. For example, a service provider might be assigned a sequence of consecutive SID numbers comprising 10001, 10003, 10005, . . . , 10013. Under the 683-B Standard, each SID of the system record requires an explicit system record entry occupying up to 53 bits in the System Table. In the exemplary embodiment of FIG. 4, the mobile telephone represents the series of SID numbers with a starting SID number and an SID range. In one embodiment, this representation is adapted to group all the consecutive SID numbers within a geographic area belonging to a single service provider with a single entry in a system range parameter block. For example, the sequence 10001, 10003, 10005, . . . , 10013 could be represented by a parameter block entry of [10001, 6] indicating six consecutive SID numbers following the first SID number 10001.

Thus, the use of the starting SID numbers and the SID ranges to represent a series of SID numbers in the PRL will allow the series of SID numbers to be defined by a single system range parameter block entry. Accordingly, the above-described representation of the SID numbers in the System Table provides a more manageable, compact, and readable PRL to conserve memory on low-capacity mobile phones and Removable User Identity Module (R-UIM) cards. Furthermore, the more compact size of the PRL provides a faster download of the PRL from a network infrastructure of a service provider such as an over-the-air function/customer service center (OTAF/CSC). After the PRL is downloaded, the entries that represent sequences of SID numbers can be expanded (decompressed) for storage into the random access memory of the mobile telephone.

The PRL download may be performed via a wireline at a CSC or wireless via an OTAF. In one embodiment, a base station of a wireless communication system can perform the functions of the OTAF/CSC to enable downloading of the compressed PRL and the parameter block. The PRL is downloaded and stored in the non-volatile memory of the mobile telephone or the R-UIM card. At system initialization, the PRL is moved into a random-access memory (RAM) of the mobile telephone or the R-UIM for later access during a System Selection and Preferred Roaming (SSPR) operation.

According to the 683-B Standard, the PRL is defined as an SSPR parameter block type with a block identification (ID) number ‘00000000’. The block ID numbers ‘00000001’ through ‘01111111’ are reserved for future standardization. In one embodiment, a parameter block with a block ID number ‘00000001’ is used to define SID ranges. However, any unused parameter block may be used to define the SID ranges. Accordingly, Table 4.5.3-1 ‘SSPR Parameter Block Types’ of the 683-B Standard may be amended to incorporate an additional entry that lists the ‘SID range’ Parameter Block Type, as shown in Table 2.

TABLE 2
SSPR Parameter Block Types

| Parameter Block Type | BLOCK_ID | Reference |
|---|---|---|
| Preferred Roaming List | ‘00000000’ | 4.5.3.1 |
| SID Range | ‘00000001’ | (Table 3) |
| Reserved for Future Standardization | ‘00000010’ | |
| | through | |
| | ‘01111111’ | |
| Available for Manufacturer-specific | ‘10000000’ | |
| Parameter Block Definitions | through | |
| | ‘11111110’ | |
| Reserved | ‘11111111’ | |

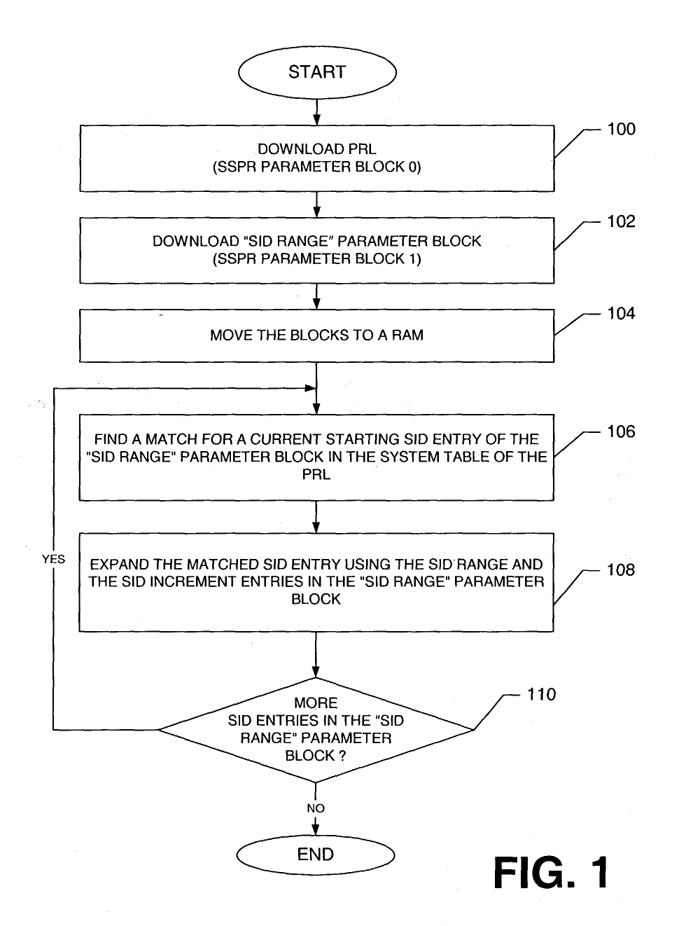

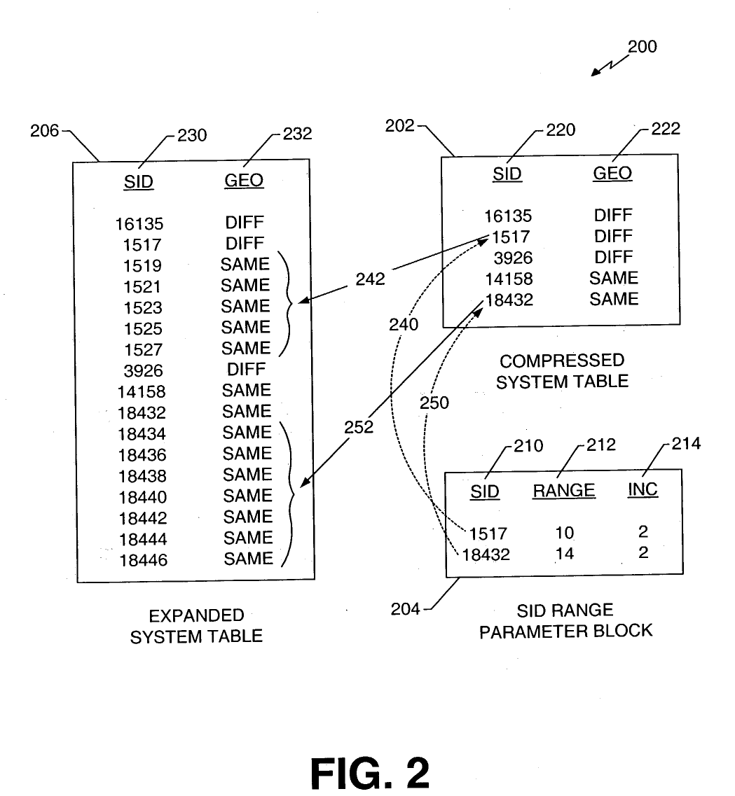

To implement the addition of the ‘SID range’ Parameter Block Type in the SSPR Download Request message and the SSPR Download Response message, a new parameter block called a “SID Range” Parameter Block that represents the series of SID numbers with an initial SID number and an SID range may be created. Furthermore, the existing system record format in the System Table may be configured to remain unchanged to maintain the backward compatibility with conventional mobile telephones. However, system record entries in the System Table are significantly reduced because a series of consecutively-numbered SID entries are replaced with a single SID number representing a starting SID number for the series of SID entries. The rest of the SID entries can be expanded at system initialization using the starting SID, the SID range, and the SID increment defined in the SID range Parameter Block, and can be accessed during the SSPR operation (see FIGS. 1 and 2). An exemplary SID range Parameter Block is shown below in Table 3.

TABLE 3
SID Range Parameter Block

| | Length | |
|---|---|---|
| Parameter | (bits) | Meaning |
| SID | 15 | Starting SID entry |
| RANGE | 15 | Ending SID entry = SID + RANGE |
| INC | 8 | SID increment |
| PRI | 1 | 0 = different than previous system record |
| | | 1 = same as previous system record |
| GEO | 1 | 0 = different than previous system record |
| | | 1 = same as previous system record |
| NAMEBIT | 1 | 0 = name present |
| | | 1 = name absent |
| ENCODING | 0 or 5 | Encoding of ALPHANAME |
| LENGTH | 0 or 8 | Number of Characters in ALPHANAME |
| ALPHANAME | 0 or 255 | Name of Provider/System |

FIG. 1 illustrates a method of operating the mobile telephone 400 (FIG. 4) for reducing the size of the System Table in a PRL in accordance with an exemplary embodiment of the invention. At 100 and 102, the PRL (including the System Table) and the SID range Parameter Block, respectively, are downloaded from the OTAF/CSC and are stored in a non-volatile memory of the mobile telephone or in an R-UIM card of the mobile telephone. As stated above, the PRL is defined as an SSPR Parameter Block ‘0’ and the SID range Parameter Block is defined as an SSPR Parameter Block ‘1’. The Parameter Blocks are moved to a random access memory (RAM) at system initialization (box 104 of FIG. 1).

A match for a current starting SID entry of the SID range Parameter Block is searched for in the System Table of the PRL, at box 106. Once the match is found, the matched SID entry is expanded using the SID range and SID increment entries in the SID range Parameter Block, as indicated at box 108. If it is determined that there are more starting SID entries in the SID range Parameter Block (box 110), the procedures in boxes 106 and 108 are repeated by processing other starting SID entries in the SID range Parameter Block.

In FIG. 2, an exemplary progression of data storage contents 200 in the mobile telephone 400 (FIG. 4) is shown, for matching and expanding an exemplary compressed System Table 202 using an exemplary SID range Parameter Block 204. The expansion process results in an expanded System Table 206 as shown in FIG. 2.

The illustrated System Tables 202 (the initial configuration), 206 (the expanded configuration), and the SID range Parameter Block 204 show only the entries or parameters that are of interest to the discussion here. Other entries or parameters have been omitted from the illustration for the sake of clarity. Further, values and positions of the SID numbers are for illustrative purposes only. The actual SID numbers and positions may be significantly different from those shown in the illustrated example.

The SID range Parameter Block 204 includes at least a starting SID entry data column 210 that should match an SID entry 220 in the System Table 202. Hence, the starting SID entry 210 corresponds with an index 240 or 250 into a system record SID entry 220 of the System Table 202 in the PRL. At system initialization (e.g., at power up), a match between the starting SID entry 210 in the SID range Parameter Block 204 and the SID entry 220 in the System Table 202 is detected. When a match is found, the matching SID entry 220 in the System Table 202 is expanded using the SID range entry 212 and the SID increment entry 214 in the SID range Parameter Block 204 corresponding to the matched SID entry 220.

For example, the first value ‘1517’ in the starting SID entry column 210 of the SID range Parameter Block 204 matches the second value in the SID entry column 220 of the compressed System Table 202. Therefore, the value ‘1517’ in the SID range Parameter Block 204 provides an index (or a pointer) 240 into the compressed System Table 202. Once the index 240 is established, the corresponding SID entry ‘1517’ in the compressed System Table 202 is expanded to provide the full range of SID entries 230 in the expanded System Table 206. The expansion process 242 involves generating additional SID entry values ‘1519’ to ‘1527’ in the expanded System Table 206 beyond the initial starting ‘1517’ value. In one embodiment, the next additional SID entry ‘1519’ is generated by incrementing the initial SID entry value ‘1517’ by the SID increment entry 214 in the SID range Parameter Block 204. This process is repeated up to the range limit (‘10’ in this example) until the last additional SID entry ‘1527’ has been generated. Thus, the last additional SID entry is determined as the last entry when the incremented SID entry (‘1527’) equals the starting SID entry (‘1517’) plus the SID range (‘10’) in the SID range Parameter Block 204.

The second SID value ‘18432’ in the starting SID entry 210 of the SID range Parameter Block 204 can be similarly matched with an index value 250 in the System Table 202 and expanded using the corresponding second SID range and SID increment values in the SID range Parameter Block 204. This expansion process 252 generates additional SID entry values ‘18434’ to ‘18446’ in the expanded System Table 206.

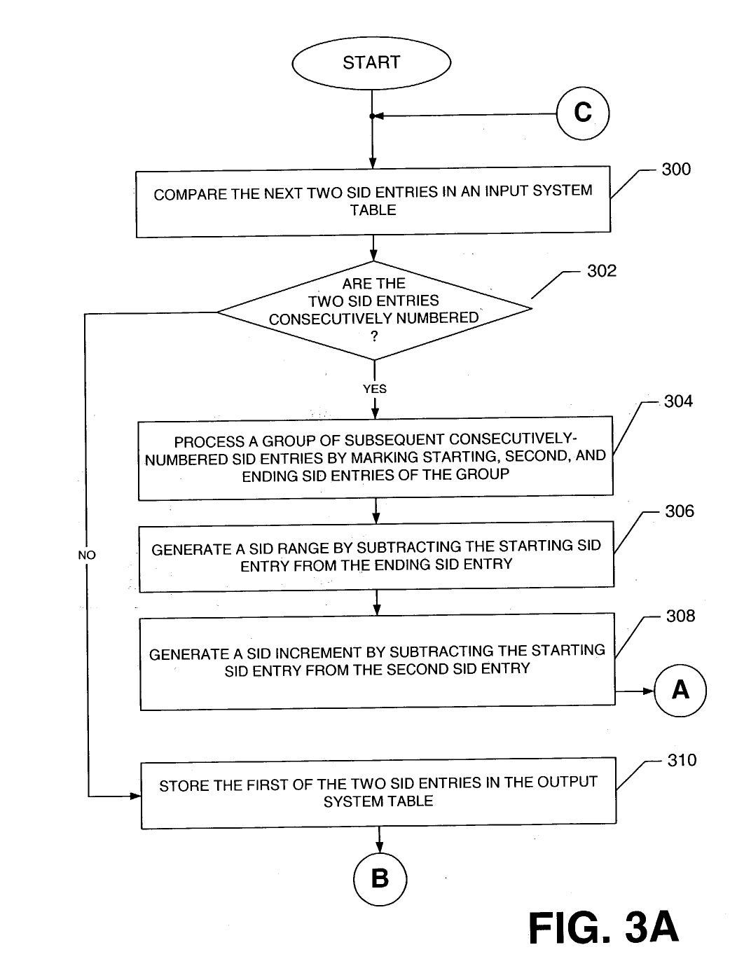

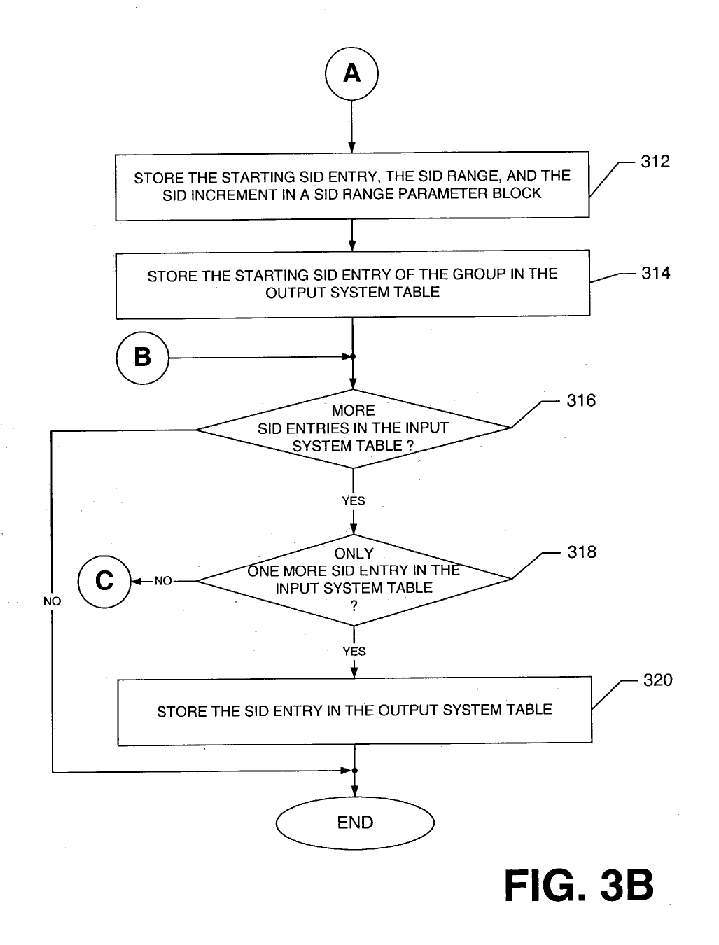

The illustrated exemplary embodiment shown in FIG. 2 may also be used in a reverse process to provide compression of a larger System Table (e.g., 206) into a smaller compressed System Table (e.g., 202) and an SID range Parameter Block (e.g., 204), which acts as a codebook for decompressing the compressed System Table 202. This reverse process, described in FIG. 3A and FIG. 3B, may be performed in the OTAF/CSC prior to storing the System Table for later download to the mobile telephone. However, a more typical way to generate a compressed System Table and an SID range Parameter Block is by building the System Table and the SID range Parameter Block when the service provider enters into roaming agreements with other service providers. For example, if a new roaming agreement is reached by a mobile telephone user's service provider with another service provider whose SID numbers extend from ‘21456’ to ‘21556’, those SID numbers should be added to the mobile telephone's System Table. The existing compressed System Table will be updated by adding one additional SID entry ‘21456’. The SID range Parameter Block will be updated to include one additional entry having a SID number of ‘21456’, a SID range of ‘100’, and a SID increment of ‘2’. This new data will be received into the mobile telephone, either by download or new memory module or the like, and then, when the System Table is expanded, all SID entries between ‘21456’ and ‘21556’ can be generated by using the parameters entered into the SID range Parameter Block.

Accordingly, using the example process described above, each SID range Parameter Block can extend a single matching SID entry found in the System Table by the parameters defined in the SID range Parameter Block. The range of expanded SID entries can start at the matched SID entry in the System Table and end at an SID number that is equal to the matched SID entry plus the SID range defined in the SID range Parameter Block. The SID entries can be incremented by an SID increment value also defined in the SID range Parameter Block. A typical value for the SID increment is two, since A side and B side SID numbers in the US Cellular Band are either odd or even.

Other parameters in the SID range Parameter Block include a Relative Priority Indicator (PRI), a Geographical Region Indicator (GEO), a name presence indicator (NAMEBIT), a name encoding indicator (ENCODING), a number of characters in the name (LENGTH), a name of the service provider/carrier (ALPHANAME). Since each SID range only represents entries for the same priority and geographic region, the values for the above-mentioned parameters will typically be fixed for all the expanded entries from a Parameter Block. Furthermore, since each SID range represents a single service provider/carrier, only one name for the service provider/carrier can be used in the SID range Parameter Block. In one embodiment, these parameters can be configured as optional parameters.

FIGS. 3A and 3B illustrate an exemplary process for generating a compressed System Table and an SID range Parameter Block using a conventional System Table with all the SID entries. In the illustrated flowchart, the conventional larger System Table is referred to as an input system table and the compressed smaller System Table is referred to as an output system table.

Processing involves comparing consecutive entries in the input system table. At box 300, the next two SID entries in the input system table are compared. The ‘next two SID entries’ are selected as the first two SID entries if this stage is at the beginning of the process. Otherwise, the ‘next two SID entries’ are selected as an SID entry pointed to by a pointer and a next SID entry after that SID entry. If it is determined, at box 302, that the two SID entries have consecutive SID numbers (i.e., the difference between SID numbers of the next two SID entries is equal to two when they are odd- or even-numbered, or are different by another predetermined value), the two SID entries plus a group of subsequent consecutively-numbered SID entries are processed, at box 304. The processing at box 304 may involve marking the starting, the second, and the ending SID entries of the group. That is, the processing of box 304 involves identifying a group of SID entries that have consecutive SID number values. An SID range is then generated, at box 306, by subtracting the starting SID entry from the ending SID entry. An SID increment is generated, at box 308, by subtracting the starting SID entry from the second SID entry. The starting SID entry, the SID range, and the SID increment are stored in an SID range Parameter Block, at box 312 (FIG. 3B). Also, the starting SID entry of the group is stored in the output system table, at box 314. In this case, a pointer for the processing of the next two SID entries (at box 300) is set to a first SID entry after the ending SID entry of the group of consecutively-numbered SID entries.

Otherwise, if it is determined, at box 302, that the two SID entries are not consecutively numbered, then the first SID entry of the two SID entries is stored in the output system table at box 310. In this alternate case, a pointer for the processing of the next two SID entries (at box 300) is set to the second SID entry of the two SID entries.

At box 316, the input system table is checked to determine if there are more SID entries in the input system table. If there are more entries to be processed, the input system table is checked, at box 318, to determine if there is only one more SID entry to be processed. If there is only one more SID entry to be processed, that SID entry is stored in the output system table, at box 320. Otherwise, if there are more than one SID entry to be processed, the SID entries in the input system table are further processed, at box 300 (FIG. 3A). If there are no more SID entries to be processed, the exemplary process is terminated.

Although the description of the exemplary process indicates storage of the SID, the SID range, and the SID increment entries only, the compression process involves storage of other parameters that are associated with the particular SID entry. These parameters, which are specified in Tables 1 and 3, have been omitted from the discussion of FIGS. 3A and 3B for the sake of clarity. In one embodiment, the exemplary compression process may be performed and the blocks stored in the OTAF/CSC prior to downloading of the blocks to the mobile telephone.

Although the operations and procedures described for reducing the size of the System Table in a PRL (FIG. 1/FIGS. 3A and 3B) and for matching and expanding a compressed System Table (FIG. 2) were presented in particular sequences, the operations/procedures may be interchanged without departing from the scope of the invention.

A block diagram of an exemplary mobile telephone 400 in communication with an over-the-air function/customer service center (OTAF/CSC) 402 is illustrated in FIG. 4. In one embodiment, before the mobile telephone 400 is put into operation, and every several months thereafter, the PRL and the SID range Parameter Block, along with other parameter blocks, are downloaded and/or updated into a non-volatile memory 424. The download process typically uses Over-the-Air Service provisioning (OTASP) to download and/or update the operating parameters used within the mobile telephone 400. The parameters are typically sent to the non-volatile memory 424 via an antenna 412, a transceiver 414, and a digital signal processor (DSP) 418. The process may be controlled by a general purpose processor (GPP) 420 via a user interface (UI) 416. In an alternative embodiment, the parameters may be sent directly to the non-volatile memory 424 via a cable/wireline.

The antenna 412 also receives forward link signals from one or more base station transceivers. The signals are appropriately amplified, filtered and otherwise processed by the transceiver 414. The output from the transceiver 414 is then applied to the DSP 418, which decodes the received forward link signals.

At system initialization, the GPP 420 moves the stored PRL and SID range Parameter Block into a random-access memory (RAM) 422 of the mobile telephone 400 or the R-UIM 430 for later access during an SSPR operation. The R-UIM 430 may also include its own central processor (CPU) 432. Boxes 430 and 432 have been delimited with dashed lines to indicate that the telephones 430, 432 are optional.

In operation, the mobile telephone 400 typically scans for a compatible service provider when the telephone 400 is first powered up. A data table or other suitable structure, such as PRUSID range Parameter Block, provides data related to possible service providers for the particular mobile telephone 400. When operating in the roaming mode, the mobile telephone 400 uses the PRUSID range Parameter Block to attempt to acquire service in a particular geographic region. When powered on, the mobile telephone 400 scans for any suitable service provider based on criteria, such as signal strength of the service provider's system, the mobile telephone's mode of operation, the mobile telephone's band of operation, and on the particular channel availability. The mobile telephone 400 selects the first service provider system that it encounters that meets the criteria for the particular mobile telephone 400.

The method or technique described in connection with the embodiments disclosed herein may be embodied directly in hardware, in program data stored as a software module that is executed by a processor, or in a combination of the two. A software module may reside in random access memory (RAM), flash memory, read-only memory (ROM), erasable programmable read-only memory (EPROM), electrically-erasable PROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a mobile station. In the alternative, the processor and the storage medium may reside as discrete components in a mobile station.

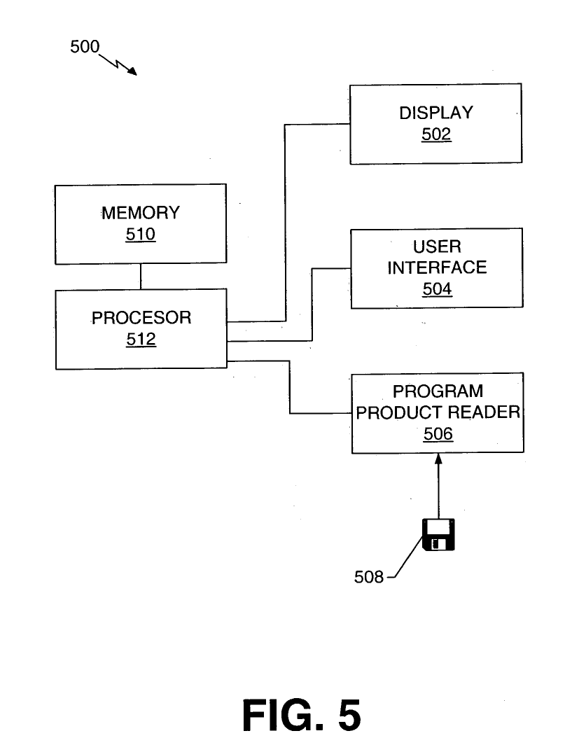

FIG. 5 is a block diagram illustrating a system 500 that incorporates and integrates the above-described modules, such as the processor 512, the memory 510, and the program product 508. The system 500 may further include a display 502, a user interface 504 such as a keyboard, and a program product reader 506 such as a disk drive.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art will further appreciate that the various illustrative logical blocks, modules, circuits, and procedures described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. For example, although the PRL and the SID range Parameter Block are described as being downloaded from the over-the-air function/customer service center (OTAF/CSC), other similar facilities or functions can be used to provide the download. In another example, although the embodiments are described in terms of reducing the size of the PRL table by reducing the parameter block entries, the reduction in size of the PRL table can be configured by compressing or reducing any possible use of ‘ranges’ in the design of the PRL table. Thus, the present invention is not intended to be limited to the embodiments shown herein but is to be accorded the widest scope consistent with the principles and novel features disclosed herein.

What is claimed is:

1. A method comprising:
obtaining data comprising a preferred roaming list (PRL) including at least a first plurality of system identification (SID) numbers that identifies a subset of available roaming systems for enabling roaming for a mobile telephone in a mobile communications network;
obtaining data comprising a parameter block including at least a second plurality of SID numbers and a corresponding plurality of SID ranges; and
expanding the subset of available roaming systems using the matched SID number and a corresponding SID range in the obtained parameter block.

2. The method of claim 1, wherein expanding the subset of available roaming systems includes matching each SID number in the obtained parameter block to a SID number in the PRL.

3. The method of claim 1, further comprising:
storing the obtained PRL and parameter block data in a non-volatile memory of the mobile telephone.

4. The method of claim 3, further comprising:
transferring the stored PRL and parameter block data to a random access memory at system initialization of the mobile telephone.

5. The method of claim 1, wherein expanding the subset of available roaming systems includes using a corresponding SID increment in the parameter block to generate subsequent SID numbers indicated by the SID range.

6. The method of claim 5, wherein expanding the subset of available roaming systems includes:
generating a group of consecutively-numbered additional SID entries for each SID number in the PRL matched to a SID number in the parameter block.

7. The method of claim 6, wherein generating a group of additional consecutively-numbered SID entries includes:
generating a plurality of SID entries starting at the matched SID number in the PRL and ending at the matched SID number plus the SID range, where each SID entry of the plurality of SID entries is generated by incrementing a prior SID entry by the SID increment.

8. A method comprising:
obtaining data comprising a compressed preferred roaming list (PRL) including a first plurality of system identification (SID) numbers that identifies roaming systems for enabling roaming for a mobile telephone in a mobile communications network;
obtaining data comprising a parameter block including a second plurality of SID numbers and a corresponding plurality of SID ranges; and
expanding the PRL such that the expanded PRL includes SID numbers corresponding to each SID number of the first plurality of SID numbers in the compressed PRL and subsequent SID numbers indicated by the SID range of the parameter block.

9. The method of claim 8, wherein expanding the PRL includes matching each SID number of the second plurality of SID numbers in the obtained parameter block to an SID number in the PRL.

10. The method of claim 8, wherein obtaining data comprising a parameter block further includes obtaining an SID increment corresponding to each SID number in the second plurality of SID numbers.

11. The method of claim 10, wherein expanding the PRL includes using the corresponding SID increment in the parameter block to generate the subsequent SID numbers indicated by the SID range.

12. A method comprising:
accessing a compressed list of available roaming systems identified with a list of roaming system identification numbers for a mobile communications network, and accessing a roaming system range parameter block including a plurality of roaming system ranges that identify roaming systems in addition to those on the compressed list, wherein the compressed list and the roaming system range parameter block enable roaming for a mobile telephone in the mobile communications network; and
generating an expanded list of available roaming systems using the compressed list of available roaming systems and the roaming system range parameter block.

13. The method of claim 12, wherein accessing a compressed list includes:
downloading the compressed list and the roaming system range parameter block into a non-volatile memory of the mobile telephone.

14. The method of claim 13, wherein downloading the compressed list and the parameter block includes:
communicating with a service provider facility; and
receiving the compressed list and the roaming system range parameter block from the service provider facility.

15. The method of claim 14, wherein communicating with a service provider includes:
communicating with an over-the-air function/customer service center (OTAF/CSC).

16. The method of claim 15, wherein communicating includes:
communicating over the air using radio frequency transmission.

17. The method of claim 15, wherein communicating includes:
communicating through a cable/wireline.

18. The method of claim 14, further comprising:
generating the compressed list and the parameter block within the service provider facility.

19. The method of claim 18, wherein generating the compressed list and the parameter block includes:
generating the compressed list and the parameter block from a larger list of available roaming systems maintained by the service provider facility.

20. The method of claim 19, wherein generating the compressed list and the parameter block includes:
comparing two consecutive entries of roaming system identification numbers in the larger list of available roaming systems.

21. The method of claim 20, further comprising:
storing a first entry of the two consecutive entries of roaming system identification numbers into the compressed list of available roaming systems, if the system identification numbers of the two consecutive entries are non-consecutively numbered.

22. The method of claim 20, further comprising:
processing a group of entries of roaming system identification numbers if the system identification numbers of the two consecutive entries are consecutively numbered, where the group of entries includes the two consecutive entries and all consecutively-numbered entries subsequent to the two consecutive entries.

23. The method of claim 22, wherein processing a group of entries includes:
marking a starting roaming system identification number in the group of entries;
marking a second roaming system identification number in the group of entries; and
marking an ending roaming system identification number in the group of entries.

24. The method of claim 23, further comprising:
generating a roaming system identification range for the group of entries by subtracting the starting roaming system identification number from the ending roaming system identification number.

25. The method of claim 24, further comprising:
generating a roaming system identification increment for the group of entries by subtracting the starting roaming system identification number from the second roaming system identification number.

26. The method of claim 25, further comprising:
storing the starting roaming system identification number, the roaming system identification range, and the roaming system identification increment in the parameter block.

27. The method of claim 26, further comprising:
storing the starting roaming system identification number into the compressed list of available roaming systems.

28. A method comprising:
obtaining data comprising an expanded preferred roaming list (PRL) including a plurality of system identification (SID) numbers that identifies roaming systems for enabling roaming for a mobile telephone in a mobile communications network;
generating a compressed PRL including a first subset of the plurality of SID numbers, where each SID number in the first subset includes every SID number in the plurality of SID numbers, but includes only a starting SID number when at least two SID numbers are in sequence;
generating a range parameter block including a second subset of the plurality of SID numbers, where each SID number in the second subset only includes the starting SID number of the at least two SID numbers that are in sequence, and a corresponding SID range.

29. The method of claim 28, wherein generating compressed PRL includes:
comparing two consecutive entries of roaming SID numbers in the expanded PRL.

30. The method of claim 29, wherein generating compressed PRL further includes:
storing a first entry of the two consecutive entries of roaming SID numbers into the compressed PRL, if the SID numbers of the two consecutive entries are non-consecutively numbered.

31. The method of claim 29, wherein generating compressed PRL further includes:
processing a group of entries of roaming SID numbers if the SID numbers of the two consecutive entries are consecutively numbered, where the group of entries includes the two consecutive entries and all consecutively-numbered entries subsequent to the two consecutive entries.

32. The method of claim 31, wherein processing a group of entries includes:
marking a starting roaming SID number in the group of entries;
marking a second roaming SID number in the group of entries; and
marking an ending roaming SID number in the group of entries.

33. The method of claim 32, further comprising:
generating a roaming system identification (SID) range for the group of entries by subtracting the starting roaming SID number from the ending roaming SID number.

34. The method of claim 33, further comprising:
generating a roaming system identification (SID) increment for the group of entries by subtracting the starting roaming SID number from the second roaming SID number.

35. The method of claim 34, further comprising:
storing the starting roaming SID number, the roaming SID range, and the roaming SID increment in the parameter block.

36. The method of claim 35, further comprising:
storing the starting roaming system identification number into the compressed PRL.

37. A mobile device for use in a mobile communications network, the mobile device comprising:
a memory configured to store data comprising a compressed list of available roaming systems identified with a list of roaming system identification numbers, and configured to store data comprising a roaming system range parameter block, wherein the range parameter block includes a plurality of roaming system ranges to identify additional roaming systems; and
a processor adapted to generate an expanded list of available roaming systems using the compressed list of available roaming systems and the roaming system range parameter block stored in the memory.

38. The mobile device of claim 37, wherein the memory includes:
a removable user identity module (R-UIM) card such that the card stores user specific parameters for the mobile device, including the compressed list of available roaming systems and the roaming system range parameter block.

39. The mobile device of claim 37, wherein the memory includes:
a non-volatile memory that stores the compressed list of available roaming systems and the roaming system range parameter block.

40. The mobile device of claim 39, wherein the memory further includes:
a random access memory that stores the compressed list of available roaming systems and the roaming system range parameter block transferred from the non-volatile memory at system initialization for later access during a System Selection and Preferred Roaming (SSPR) operation.

41. A mobile communications network comprising:
a base station; and
a mobile station in communication with the base station, the mobile station including:
a memory configured to store data comprising a compressed list of available roaming systems identified with a list of roaming system identification numbers, and to store data comprising a roaming system range parameter block, wherein the parameter block includes a plurality of roaming system ranges to identify additional roaming systems, and
a processor adapted to generate an expanded list of available roaming systems using the compressed list of available roaming systems and the roaming system range parameter block stored in the memory.

42. The mobile communications network of claim 41, further comprising:
an over-the-air function/customer service center (OTAF/CSC) operating to provide the compressed list of available roaming systems and the roaming system range parameter block to the mobile station for later use during a System Selection and Preferred Roaming (SSPR) operation.

43. A program product for use in a computer that executes program instructions recorded in a computer-readable media to enable roaming for a mobile station in a mobile communications network, the program product comprising:
a recordable media; and
a plurality of computer-readable program instructions on the recordable media that are executable by the computer to perform a method comprising:
obtaining data comprising a preferred roaming list (PRL) including at least a first plurality of system identification (SID) numbers that identifies a subset of available roaming systems for enabling roaming for a mobile device in a mobile communications network;
obtaining data comprising a parameter block including at least a second plurality of SID numbers and a corresponding plurality of SID ranges; and
expanding the subset of available roaming systems using the matched SID number and a corresponding SID range in the obtained parameter block.

44. The program product of claim 43, wherein expanding the subset of available roaming systems includes matching each SID number in the obtained parameter block to a SID number in the PRL.

45. The program product of claim 43, further comprising:
storing the obtained PRL and parameter block data in a non-volatile memory of the mobile device.

46. The program product of claim 45, further comprising:
transferring the stored PRL and parameter block data to a random access memory at system initialization of the mobile device.

47. The program product of claim 43, wherein expanding the subset of available roaming systems includes using a corresponding SID increment in the parameter block to generate subsequent SID numbers indicated by the SID range.

48. The program product of claim 47, wherein expanding the subset of available roaming systems includes:
generating a group of consecutively-numbered additional SID entries for each SID number in the PRL matched to a SID number in the parameter block.

49. The program product of claim 48, wherein generating a group of additional consecutively-numbered SID entries includes:
generating a plurality of SID entries starting at the matched SID number in the PRL and ending at the matched SID number plus the SID range, where each SID entry of the plurality of SID entries is generated by incrementing a prior SID entry by the SID increment.

50. A program product for use in a computer that executes program instructions recorded in a computer-readable media to enable roaming for a mobile station in a mobile communications network, the program product comprising:
a recordable media; and
a plurality of computer-readable program instructions on the recordable media that are executable by the computer to perform a method comprising:
obtaining data comprising a compressed preferred roaming list (PRL) including a first plurality of system identification (SID) numbers that identifies roaming systems for enabling roaming for a mobile device in a mobile communications network;
obtaining data comprising a parameter block including a second plurality of SID numbers and a corresponding plurality of SID ranges; and
expanding the PRL such that the expanded PRL includes SID numbers corresponding to each SID number of the first plurality of SID numbers in the compressed PRL and subsequent SID numbers indicated by the SID range of the parameter block.

51. The program product of claim 50, wherein expanding the PRL includes matching each SID number of the second plurality of SID numbers in the obtained parameter block to an SID number in the PRL.

52. The program product of claim 50, wherein obtaining data comprising a parameter block further includes obtaining an SID increment corresponding to each SID number in the second plurality of SID numbers.

53. The program product of claim 52, wherein expanding the PRL includes using the corresponding SID increment in the parameter block to generate the subsequent SID numbers indicated by the SID range.

54. A program product for use in a computer that executes program instructions recorded in a computer-readable media to enable roaming for a mobile station in a mobile communications network, the program product comprising:
a recordable media; and
a plurality of computer-readable program instructions on the recordable media that are executable by the computer to perform a method comprising:
obtaining data comprising an expanded preferred roaming list (PRL) including a plurality of system identification (SID) numbers that identifies roaming systems for enabling roaming for a mobile device in a mobile communications network;
generating a compressed PRL including a first subset of the plurality of SID numbers, where each SID number in the first subset includes every SID number in the plurality of SID numbers, but includes only a starting SID number when at least two SID numbers are in sequence;
generating a range parameter block including a second subset of the plurality of SID numbers, where each SID number in the second subset only includes the starting SID number of the at least two SID numbers that are in sequence, and a corresponding SID range.

55. The program product of claim 54, wherein generating compressed PRL includes:
comparing two consecutive entries of roaming SID numbers in the expanded PRL.

56. The program product of claim 55, wherein generating compressed PRL further includes:
storing a first entry of the two consecutive entries of roaming SID numbers into the compressed PRL, if the SID numbers of the two consecutive entries are non-consecutively numbered.

57. The program product of claim 55, wherein generating compressed PRL further includes:
processing a group of entries of roaming SID numbers if the SID numbers of the two consecutive entries are consecutively numbered, where the group of entries includes the two consecutive entries and all consecutively-numbered entries subsequent to the two consecutive entries.

58. The program product of claim 57, wherein processing a group of entries includes:
marking a starting roaming SID number in the group of entries;
marking a second roaming SID number in the group of entries; and
marking an ending roaming SID number in the group of entries.

59. The program product of claim 58, further comprising:
generating a roaming system identification (SID) range for the group of entries by subtracting the starting roaming SID number from the ending roaming SID number.

60. The program product of claim 59, further comprising:
generating a roaming system identification (SID) increment for the group of entries by subtracting the starting roaming SID number from the second roaming SID number.

61. The program product of claim 60, further comprising:
storing the starting roaming SID number, the roaming SID range, and the roaming SID increment in the parameter block.

62. The program product of claim 61, further comprising:
storing the starting roaming system identification number into the compressed PRL.

63. An apparatus of a network infrastructure, comprising:
a memory configured to store data comprising a compressed list of available roaming systems identified with a list of roaming system identification numbers, and configured to store data comprising a roaming system range parameter block, wherein the range parameter block includes a plurality of roaming system ranges to identify additional roaming systems; and
a transceiver adapted to enable downloading of the compressed list of available roaming systems and the roaming system range parameter block.

64. The apparatus of claim 63, wherein the network infrastructure is an over-the-air function/customer service center (OTAF/CSC).

65. The apparatus of claim 63, wherein the network infrastructure is a base station.

66. The apparatus of claim 63, wherein the transceiver includes a radio frequency (RF) transmitter to enable the downloading of the compressed list of available roaming systems and the roaming system range parameter block over the air using RF transmission.

67. The apparatus of claim 63, wherein the transceiver includes an adapter to enable the downloading of the compressed list of available roaming systems and the roaming system range parameter block over a cable/wireline.

68. The apparatus of claim 63, further comprising:
a processor configured to generate the compressed list of available roaming systems and the roaming system range parameter block from an expanded list of available roaming systems.

69. The apparatus of claim 68, wherein the expanded list of available roaming systems includes an expanded list of preferred roaming list (PRL).

70. The apparatus of claim 69, wherein the processor includes:
a comparator to compare two consecutive entries of roaming SID numbers in the expanded PRL.

71. The apparatus of claim 70, further comprising:
a storage device to store a first entry of the two consecutive entries of roaming SID numbers into the compressed PRL, if the SID numbers of the two consecutive entries are non-consecutively numbered.

72. The apparatus of claim 70, wherein the processor includes:
a processing element to process a group of entries of roaming SID numbers if the SID numbers of the two consecutive entries are consecutively numbered, where the group of entries includes the two consecutive entries and all consecutively-numbered entries subsequent to the two consecutive entries.

73. The apparatus of claim 72, wherein the processing element includes:
a first marker to mark a starting roaming SID number in the group of entries;
a second marker to mark a second roaming SID number in the group of entries; and
a third marker to mark an ending roaming SID number in the group of entries.

74. The apparatus of claim 73, wherein the processing element further includes:
a first generator to generate a roaming system identification (SID) range for the group of entries by subtracting the starting roaming SID number from the ending roaming SID number.

75. The apparatus of claim 74, wherein the processing element further includes:
a second generator to generate a roaming system identification (SID) increment for the group of entries by subtracting the starting roaming SID number from the second roaming SID number.

76. A mobile device for use in a mobile communications network, the mobile device comprising:
memory means for storing data comprising a compressed list of available roaming systems identified with a list of roaming system identification numbers, and for storing data comprising a roaming system range parameter block, wherein the range parameter block includes a plurality of roaming system ranges to identify additional roaming systems; and
means for processing the compressed list of available roaming systems and the roaming system range parameter block stored in the memory, and generating an expanded list of available roaming systems.

77. The mobile device of claim 76, wherein the mobile device includes a mobile telephone.

78. The mobile device of claim 77, wherein the memory means includes:
removable means for identifying a user of the mobile telephone such that the card stores user specific parameters for the mobile telephone, including the compressed list of available roaming systems and the roaming system range parameter block.

79. The mobile device of claim 76, wherein the memory means includes:
non-volatile memory means for storing the compressed list of available roaming systems and the roaming system range parameter block.

80. The mobile device of claim 79, wherein the memory means further includes:
random access memory means for storing the compressed list of available roaming systems and the roaming system range parameter block transferred from the non-volatile memory means at system initialization for later access during a System Selection and Preferred Roaming (SSPR) operation.
